(19) United States
(12) Patent Application Publication
(10) Pub. No.: US 2003/0168819 A1
(43) Pub. Date: Sep. 11, 2003

(54) Seal system

(76) Inventor: Holger Gutschmidt, Neu Wulmstorf (DE)

Correspondence Address: WILLIAM COLLARD, COLLARD & ROE, P.C., 1077 NORTHERN BOULEVARD, ROSLYN, NY, 11576, US

(21) Appl. No.: 10/333,575

(22) PCT Filed: May 17, 2002
(86) PCT No.: PCT/DE02/01775

(30) Foreign Application Priority Data
May 30, 2001 (DE) 101 26 292.2

(51) Int. Cl. F16J 15/02

(52) U.S. Cl. 277/628

(57) ABSTRACT

The invention relates to a seal arrangement, consisting at least of:

two abutting components made of concrete, steel-reinforced concrete, or another curable material, as well as a sealing profile (1) made of elastomer material, which bridges the gap between the two components, forming a seal, and which has at least one anchoring foot (5) within its base region, by means of which a permanent attachment in the corresponding component takes place;

whereby the abutting components are, in particular, segments that are put together to form a tube-shaped tunnel, specifically forming crosswise and lengthwise joins, whereby each segment is equipped, on its abutting end, with a sealing profile (1) that is permanently attached in the segment by means of at least one anchoring foot (5).

The seal arrangement according to the invention is now characterized in that

the anchoring foot (5) is provided with slits (9) in the crosswise profile direction X, which are arranged at a distance b from one another in the lengthwise profile direction Y.

The invention relates to a seal arrangement, consisting at least of:

two abutting components made of concrete, steel-reinforced concrete, or another curable material (e.g. plastic resin), as well as a sealing profile made of elastomer material, which bridges the gap between the two components, forming a seal, and which has at least one anchoring foot within its base region, by means of which a permanent attachment in the corresponding component takes place;

whereby the abutting components are, in particular, segments that are put together to form a tube-shaped tunnel, specifically forming crosswise and lengthwise joins, whereby each segment is equipped, on its abutting end, with a sealing profile that is permanently attached in the segment by means of at least one anchoring foot.

A sealing arrangement of this type is described, for example, in the references DE 39 34 198 C2, WO 99/54593 A1, and WO 01/53657 A1.

Within the scope of a further development, the task consists of making available an anchored sealing profile that allows an optimal escape of air bubbles during the casting process (e.g. concrete pouring process), independent of the shape and the number of anchoring feet.

For the purpose of accomplishing this task, the seal arrangement is now characterized, according to the characterizing part of claim 1, in that the anchoring foot is provided with slits in the crosswise profile direction X, which are arranged at a distance b from one another in the lengthwise profile direction Y.

Practical embodiments of the seal arrangement according to the invention are named in claims 2 to 5.

The invention will now be described on the basis of an exemplary embodiment, making reference to schematic drawings. These show:

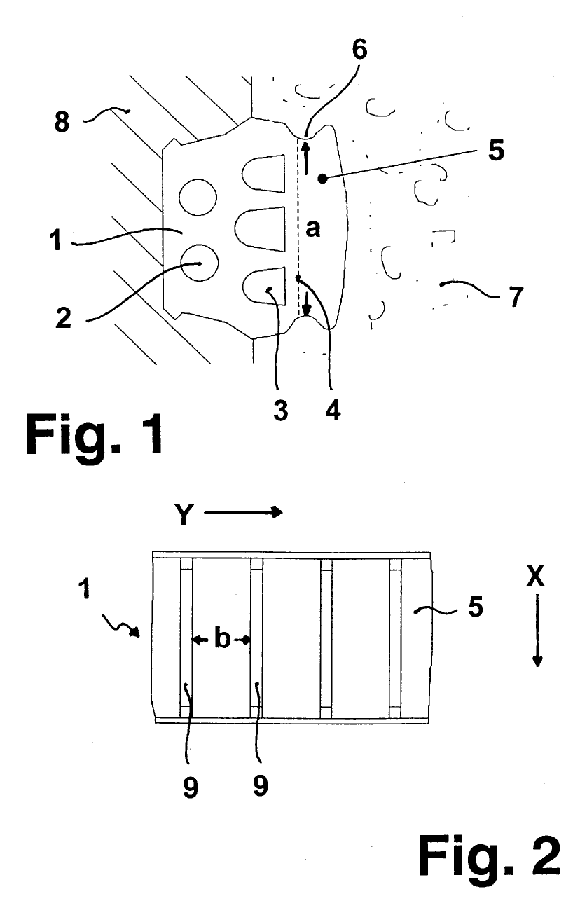

FIG. 1 a cross-section through an anchored sealing profile;

FIG. 2 an anchoring foot with slits.

FIG. 1 shows a sealing profile 1 made of elastomer material as an extrudate, which is equipped, in most instances, with several oblong holes 2 and 3, particularly within the scope of a two-row arrangement principle, for the purpose of increasing elasticity. Within its base region 4, the sealing profile has a single anchoring foot 5, which essentially takes up the entire width a of the base region. In addition, the anchoring foot is provided with an undercut 6.

The sealing profile 1 is now firmly anchored in the segment 7 made of concrete, by means of the anchoring foot 5. When the concrete is poured, a casting form 8 is required, which is removed after the concrete has hardened. As far as details of casting form technology are concerned, reference is particularly made to the state of the art as cited initially.

FIG. 2 now shows a sealing profile 1 whose anchoring foot 5 is provided with slits 9 in the crosswise profile direction X, which slits are arranged at a distance b from one another in the lengthwise profile direction Y. In this connection, the distance between the slits is approximately the same. An optimal escape of air bubbles during the concrete pouring process is now made possible by means of these slits, so that no defect spots that impair the efficacy of the anchoring are formed.

This measure is of particular importance in tunnel construction (U.S. Pat. No. 4,946,309). But this anchoring concept is of interest also for socket pipes and shaft constructions (EP 0 479 172 B1).

### REFERENCE SYMBOL LIST

1 sealing profile

2 oblong hole

3 oblong hole (closed ribbed groove)

4 base region

5 anchoring foot

6 undercut

7 segment (e.g. concrete segment)

9 casting form

9 slit

a width of the base region

b distance between two slits

X crosswise profile direction

Y lengthwise profile direction

1. Seal arrangement, consisting at least of:
two abutting components made of concrete, steel-reinforced concrete, or another curable material, as well as a sealing profile (1) made of elastomer material, which bridges the gap between the two components, forming a seal, and which has at least one anchoring foot (5) within its base region (4), by means of which a permanent attachment in the corresponding component takes place;
whereby the abutting components are, in particular, segments (7) that are put together to form a tube-shaped tunnel, specifically forming crosswise and lengthwise joins, whereby each segment is equipped, on its abutting end, with a sealing profile (1) that is permanently attached in the segment (7) by means of at least one anchoring foot (5),
characterized in that
the anchoring foot (5) is provided with slits (9) in the crosswise profile direction X, which are arranged at a distance b from one another in the lengthwise profile direction Y.

2. Seal arrangement according to claim 1, characterized in that only a single anchoring foot (5) is present within the base region (4) of the sealing profile (1).

3. Seal arrangement according to claim 2, characterized in that the single anchoring foot (5) essentially takes up the entire width a of the base region (4).

4. Seal arrangement according to one of claims 1 to 3, characterized in that the anchoring foot (5) has at least one undercut (6).

5. Seal arrangement according to one of claims 1 to 4, characterized in that the distance b between the slits (9) is approximately the same in each instance.
